(19) United States
(12) Patent Application Publication
(10) Pub. No.: US 2024/0091962 A1
(43) Pub. Date: Mar. 21, 2024

(54) Robotic Gripping Device for Grasping Handles and Objects

(71) Applicant: X Development LLC, Mountain View, CA (US)

(72) Inventor: Marc Strauss, Tualatin, OR (US)

(21) Appl. No.: 17/932,371

(22) Filed: Sep. 15, 2022

(51) Int. Cl. B25J 15/08; B25J 9/16; B25J 15/00

(52) U.S. Cl. CPC B25J 15/08; B25J 9/1612; B25J 15/0004

(57) ABSTRACT

An apparatus is described comprising a first gripping component having a first proximal region having a first rigid geometry configured to receive a handle of a tool and a first distal region having a first shape-adaptive finger and a second gripping component having a second proximal region having a second rigid geometry configured to receive the handle of the tool and a second distal region having a second shape-adaptive finger. The first distal region is separated by a clearance from the second distal region when the first rigid geometry and the second rigid geometry are grasping the handle of the tool and, in an absence of the handle of the tool, the first proximal region and the second proximal region enable a pinch grip between the first shape-adaptive finger of the first gripping component and the second shape-adaptive finger of the second gripping component.

### BACKGROUND

As technology advances, various types of robotic devices are being created for performing a variety of functions that may assist users. Robotic devices may be used for applications involving material handling, transportation, welding, assembly, and dispensing, among others. Over time, the manner in which these robotic systems operate is becoming more intelligent, efficient, and intuitive. As robotic systems become increasingly prevalent in numerous aspects of modern life, it is desirable for robotic systems to be efficient. Therefore, a demand for efficient robotic systems has helped open up a field of innovation in actuators, movement, sensing techniques, as well as component design and assembly.

Robotic devices, such as robotic legs and arms, may include various components or attachments that are designed to interact with the environment. Such components may include robotic feet and hands, which may include additional components that can be used to support, stabilize, grip, and otherwise allow a robotic device to effectively carry out one or more actions.

In particular, robotic arms may include one or more “end effectors” that interact with the environment. For example, end effectors may be impactive (such as a claw), ingressive (such as a pin or needle), astrictive (such as a vacuum or suction element) or contigutive (requiring contact for adhesion, such as glue).

End effectors are any devices designed to interact with the environment that are components of robotic manipulators (e.g., robotic arms) or can be attached at the end of robotic manipulators. End effectors may include a gripper having a variety of potential gripping surfaces, such as jaws, claws, or mechanical fingers. The shape of the gripping surface can be chosen according to the shape of the objects that are intended to be manipulated by the gripper. However, it is difficult to optimize an end effector for more than one purpose, or type of grasp. For instance, a pinching grasp and an enveloping grasp are often not able to be effectively and efficiently performed by the same end effector set-up.

### SUMMARY

The present application discloses implementations that relate to robot grippers that are able to effectively and efficiently achieve various grasp types without having to reconfigure the robotic grippers. A robotic gripping device may include two gripping components, arranged opposite each other, that may include multiple portions suited for the desired tasks.

For instance, in one example, the present application describes an apparatus comprising a first gripping component having a first proximal region having a first rigid geometry configured to receive a handle of a tool and a first distal region having a first shape-adaptive finger and a second gripping component having a second proximal region having a second rigid geometry configured to receive the handle of the tool and a second distal region having a second shape-adaptive finger. The first distal region is separated by a clearance from the second distal region when the first rigid geometry and the second rigid geometry are grasping the handle of the tool and, in an absence of the handle of the tool, the first proximal region and the second proximal region enable a pinch grip between the first shape-adaptive finger of the first gripping component and the second shape-adaptive finger of the second gripping component.

In another example, the present application describes a method comprising actuating a first gripping component comprising a first proximal region having a first rigid geometry configured to receive a handle of a tool and a first distal region having a first shape-adaptive finger and actuating a second gripping component comprising a second proximal region having a second rigid geometry configured to receive a handle of a tool and a second distal region having a second shape-adaptive finger. In an absence of the handle of the tool, the method includes enabling, by the first proximal region of the first gripping component and the second proximal region of the second gripping component, a pinch grip between the first shape-adaptive finger of the first gripping component and the second shape-adaptive finger of the second gripping component.

In a third example, the present application describes a robotic device including a robotic gripping apparatus having a first gripping component having a first proximal region having a first rigid geometry configured to receive a handle of a tool and a first distal region having a first shape-adaptive finger and a second gripping component having a second proximal region having a second rigid geometry configured to receive the handle of the tool and a second distal region having a second shape-adaptive finger. The first distal region is separated by a clearance from the second distal region when the first rigid geometry and the second rigid geometry are grasping the handle of the tool and, in an absence of the handle of the tool, the first proximal region and the second proximal region enable a pinch grip between the first shape-adaptive finger of the first gripping component and the second shape-adaptive finger of the second gripping component.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE DRAWINGS

FIG. 1 illustrates a configuration of a robotic system, in accordance with example embodiments.

FIG. 2 illustrates a mobile robot, in accordance with example embodiments.

FIG. 3 illustrates an exploded view of a mobile robot, in accordance with example embodiments.

FIG. 4 illustrates a robotic arm, in accordance with example embodiments.

FIG. 5A is a depiction of a robotic gripping apparatus, according to example embodiments.

FIG. 5B is a depiction of the apparatus in FIG. 5A, according to example embodiments.

FIG. 5C is a depiction of the apparatus in FIG. 5A, according to example embodiments.

FIG. 5D is a depiction of the apparatus in FIG. 5A, according to example embodiments.

FIGS. 6A, 6B, and 6C are top views of a proximal region of a gripping component comprising tines, according to example embodiments.

FIGS. 7A, 7B, and 7C are top views of a proximal region of a gripping component comprising tines, according to example embodiments.

FIG. 8A is a depiction of an apparatus, according to example embodiments.

FIG. 8B is a depiction of the apparatus in FIG. 8A, according to example embodiments.

FIG. 8C is a depiction of the apparatus in FIG. 8A, according to example embodiments.

FIG. 8D is a depiction of the apparatus in FIG. 8A, according to example embodiments.

FIG. 8E is a depiction of the apparatus in FIG. 8A, according to example embodiments.

FIG. 9 is a flowchart of a method, according to example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless indicated as such. Other embodiments can be utilized, and other changes can be made, without departing from the scope of the subject matter presented herein.

Thus, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Throughout this description, the articles “a” or “an” are used to introduce elements of the example embodiments. Any reference to “a” or “an” refers to “at least one,” and any reference to “the” refers to “the at least one,” unless otherwise specified, or unless the context clearly dictates otherwise. The intent of using the conjunction “or” within a described list of at least two terms is to indicate any of the listed terms or any combination of the listed terms.

The use of ordinal numbers such as “first,” “second,” “third” and so on is to distinguish respective elements rather than to denote a particular order of those elements. For purpose of this description, the terms “multiple” and “a plurality of” refer to “two or more” or “more than one.”

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment. In the figures, similar symbols typically identify similar components, unless context dictates otherwise. Further, unless otherwise noted, figures are not drawn to scale and are used for illustrative purposes only. Moreover, the figures are representational only and not all components are shown. For example, additional structural or restraining components might not be shown.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

I. Overview

A robotic device may be used for a variety of applications to streamline processes, such as material handling, transportation, assembly, and manufacturing. For some applications, a robotic device may need to effectively and efficiently achieve various grasp types without having to reconfigure a robotic gripper. As disclosed herein, a robotic gripping device may include two gripping components, arranged opposite each other, that may include multiple portions suited for the desired tasks.

In some examples, a robotic gripper may be controlled to perform a series of tasks that require different types of gripping actions, such as grasping/enveloping and pinching. Generally, it is difficult and inefficient to use a robotic gripping device designed to grasp something to instead pinch something and vice versa. In addition, sometimes there is not enough force and/or control in a robotic gripping device designed for one type of grip to be used for another type of grip that it was not designed for. For instance, a robotic gripping device that is designed to pinch an object might not have enough force and/or control to complete a task that requires an enveloping grip, such as holding a handle of a tool and utilizing said tool.

Proposed herein are robotic gripping components capable of efficiently achieving multiple grasp types without requiring an assembly change of end effectors on the robot or otherwise creating unnecessary inefficiency. These robotic gripping devices may be used in a variety of applications requiring multiple types of grips to complete one or more tasks. For example, a robotic device may be charged with cleaning a room, including tasks such as vacuuming the room as well as clearing off a table. The robotic gripping components proposed herein may be able to envelope a handle of a tool, such as a vacuum, to complete that portion of the task but may also be able to pinch and grab items, such as water bottles or cans, from the table in order to dispose of them.

Example robotic gripping devices disclosed herein may eliminate the need in the above scenario or other similar scenarios to use multiple robotic devices such that each robotic device is structured with a single type of gripping component and tasked only with duties requiring use of that type of gripping component. Example robotic gripping devices disclosed herein may also eliminate the need to use a singular robotic device with interchangeable gripping components and the need to use the time and energy to exchange a first type of end effector suitable for some tasks with a second type of end effector suitable for other tasks. Instead, example robotic gripping devices disclosed herein may include a first gripping component and a second gripping component that are configured such that an enveloping-type grasp may be performed between a portion of the two gripping components and a pinch-type grasp may be performed between another portion of the two gripping components without having to change the configuration of the robotic device at all.

In examples described herein, proximal regions of the gripping components may be designed to enable a pinch grip between distal regions of the gripping components. More specifically, the opposing motion of the proximal regions, a maintained clearance therebetween, and the specific geometry of the distal regions with respect to each other (and to the proximal regions) are factors which may contribute to enable the pinch grip.

II. Example Robotic Systems

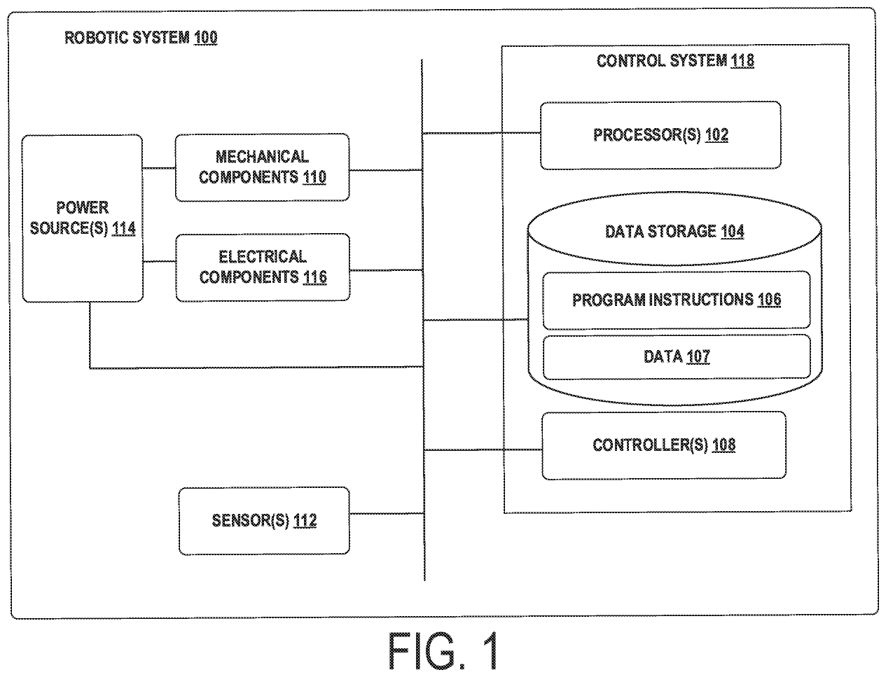

FIG. 1 illustrates an example configuration of a robotic system that may be used in connection with the implementations described herein. Robotic system 100 may be configured to operate autonomously, semi-autonomously, or using directions provided by user(s). Robotic system 100 may be implemented in various forms, such as a robotic arm, industrial robot, or some other arrangement. Some example implementations involve a robotic system 100 engineered to be low cost at scale and designed to support a variety of tasks. Robotic system 100 may be designed to be capable of operating around people. Robotic system 100 may also be optimized for machine learning. Throughout this description, robotic system 100 may also be referred to as a robot, robotic device, or mobile robot, among other designations.

As shown in FIG. 1, robotic system 100 may include processor(s) 102, data storage 104, and controller(s) 108, which together may be part of control system 118. Robotic system 100 may also include sensor(s) 112, power source(s) 114, mechanical components 110, and electrical components 116. Nonetheless, robotic system 100 is shown for illustrative purposes, and may include more or fewer components. The various components of robotic system 100 may be connected in any manner, including wired or wireless connections. Further, in some examples, components of robotic system 100 may be distributed among multiple physical entities rather than a single physical entity. Other example illustrations of robotic system 100 may exist as well.

Processor(s) 102 may operate as one or more general-purpose hardware processors or special purpose hardware processors (e.g., digital signal processors, application specific integrated circuits, etc.). Processor(s) 102 may be configured to execute computer-readable program instructions 106, and manipulate data 107, both of which are stored in data storage 104. Processor(s) 102 may also directly or indirectly interact with other components of robotic system 100, such as sensor(s) 112, power source(s) 114, mechanical components 110, or electrical components 116.

Data storage 104 may be one or more types of hardware memory. For example, data storage 104 may include or take the form of one or more computer-readable storage media that can be read or accessed by processor(s) 102. The one or more computer-readable storage media can include volatile or non-volatile storage components, such as optical, magnetic, organic, or another type of memory or storage, which can be integrated in whole or in part with processor(s) 102. In some implementations, data storage 104 can be a single physical device. In other implementations, data storage 104 can be implemented using two or more physical devices, which may communicate with one another via wired or wireless communication. As noted previously, data storage 104 may include the computer-readable program instructions 106 and data 107. Data 107 may be any type of data, such as configuration data, sensor data, or diagnostic data, among other possibilities.

Controller 108 may include one or more electrical circuits, units of digital logic, computer chips, or microprocessors that are configured to (perhaps among other tasks), interface between any combination of mechanical components 110, sensor(s) 112, power source(s) 114, electrical components 116, control system 118, or a user of robotic system 100. In some implementations, controller 108 may be a purpose-built embedded device for performing specific operations with one or more subsystems of the robotic system 100.

Control system 118 may monitor and physically change the operating conditions of robotic system 100. In doing so, control system 118 may serve as a link between portions of robotic system 100, such as between mechanical components 110 or electrical components 116. In some instances, control system 118 may serve as an interface between robotic system 100 and another computing device. Further, control system 118 may serve as an interface between robotic system 100 and a user. In some instances, control system 118 may include various components for communicating with robotic system 100, including a joystick, buttons, or ports, etc. The example interfaces and communications noted above may be implemented via a wired or wireless connection, or both. Control system 118 may perform other operations for robotic system 100 as well.

During operation, control system 118 may communicate with other systems of robotic system 100 via wired or wireless connections, and may further be configured to communicate with one or more users of the robot. As one possible illustration, control system 118 may receive an input (e.g., from a user or from another robot) indicating an instruction to perform a requested task, such as to pick up and move an object from one location to another location. Based on this input, control system 118 may perform operations to cause the robotic system 100 to make a sequence of movements to perform the requested task. As another illustration, a control system may receive an input indicating an instruction to move to a requested location. In response, control system 118 (perhaps with the assistance of other components or systems) may determine a direction and speed to move robotic system 100 through an environment en route to the requested location.

Operations of control system 118 may be carried out by processor(s) 102. Alternatively, these operations may be carried out by controller(s) 108, or a combination of processor(s) 102 and controller(s) 108. In some implementations, control system 118 may partially or wholly reside on a device other than robotic system 100, and therefore may at least in part control robotic system 100 remotely.

Mechanical components 110 represent hardware of robotic system 100 that may enable robotic system 100 to perform physical operations. As a few examples, robotic system 100 may include one or more physical members, such as an arm, an end effector, a head, a neck, a torso, a base, and wheels. The physical members or other parts of robotic system 100 may further include actuators arranged to move the physical members in relation to one another. Robotic system 100 may also include one or more structured bodies for housing control system 118 or other components, and may further include other types of mechanical components. The particular mechanical components 110 used in a given robot may vary based on the design of the robot, and may also be based on the operations or tasks the robot may be configured to perform.

In some examples, mechanical components 110 may include one or more removable components. Robotic system 100 may be configured to add or remove such removable components, which may involve assistance from a user or another robot. For example, robotic system 100 may be configured with removable end effectors or digits that can be replaced or changed as needed or desired. In some implementations, robotic system 100 may include one or more removable or replaceable battery units, control systems, power systems, bumpers, or sensors. Other types of removable components may be included within some implementations.

Robotic system 100 may include sensor(s) 112 arranged to sense aspects of robotic system 100. Sensor(s) 112 may include one or more force sensors, torque sensors, velocity sensors, acceleration sensors, position sensors, proximity sensors, motion sensors, location sensors, load sensors, temperature sensors, touch sensors, depth sensors, ultrasonic range sensors, infrared sensors, object sensors, or cameras, among other possibilities. Within some examples, robotic system 100 may be configured to receive sensor data from sensors that are physically separated from the robot (e.g., sensors that are positioned on other robots or located within the environment in which the robot is operating).

Sensor(s) 112 may provide sensor data to processor(s) 102 (perhaps by way of data 107) to allow for interaction of robotic system 100 with its environment, as well as monitoring of the operation of robotic system 100. The sensor data may be used in evaluation of various factors for activation, movement, and deactivation of mechanical components 110 and electrical components 116 by control system 118. For example, sensor(s) 112 may capture data corresponding to the terrain of the environment or location of nearby objects, which may assist with environment recognition and navigation.

In some examples, sensor(s) 112 may include RADAR (e.g., for long-range object detection, distance determination, or speed determination), LIDAR (e.g., for short-range object detection, distance determination, or speed determination), SONAR (e.g., for underwater object detection, distance determination, or speed determination), VICON® (e.g., for motion capture), one or more cameras (e.g., stereoscopic cameras for 3D vision), a global positioning system (GPS) transceiver, or other sensors for capturing information of the environment in which robotic system 100 is operating. Sensor(s) 112 may monitor the environment in real time, and detect obstacles, elements of the terrain, weather conditions, temperature, or other aspects of the environment. In another example, sensor(s) 112 may capture data corresponding to one or more characteristics of a target or identified object, such as a size, shape, profile, structure, or orientation of the object.

Further, robotic system 100 may include sensor(s) 112 configured to receive information indicative of the state of robotic system 100, including sensor(s) 112 that may monitor the state of the various components of robotic system 100. Sensor(s) 112 may measure activity of systems of robotic system 100 and receive information based on the operation of the various features of robotic system 100, such as the operation of an extendable arm, an end effector, or other mechanical or electrical features of robotic system 100. The data provided by sensor(s) 112 may enable control system 118 to determine errors in operation as well as monitor overall operation of components of robotic system 100.

As an example, robotic system 100 may use force/torque sensors to measure load on various components of robotic system 100. In some implementations, robotic system 100 may include one or more force/torque sensors on an arm or end effector to measure the load on the actuators that move one or more members of the arm or end effector. In some examples, the robotic system 100 may include a force/torque sensor at or near the wrist or end effector, but not at or near other joints of a robotic arm. In further examples, robotic system 100 may use one or more position sensors to sense the position of the actuators of the robotic system. For instance, such position sensors may sense states of extension, retraction, positioning, or rotation of the actuators on an arm or end effector.

As another example, sensor(s) 112 may include one or more velocity or acceleration sensors. For instance, sensor(s) 112 may include an IMU. The IMU may sense velocity and acceleration in the world frame, with respect to the gravity vector. The velocity and acceleration sensed by the IMU may then be translated to that of robotic system 100 based on the location of the IMU in robotic system 100 and the kinematics of robotic system 100.

Robotic system 100 may include other types of sensors not explicitly discussed herein. Additionally or alternatively, the robotic system may use particular sensors for purposes not enumerated herein.

Robotic system 100 may also include one or more power source(s) 114 configured to supply power to various components of robotic system 100. Among other possible power systems, robotic system 100 may include a hydraulic system, electrical system, batteries, or other types of power systems. As an example illustration, robotic system 100 may include one or more batteries configured to provide charge to components of robotic system 100. Some of mechanical components 110 or electrical components 116 may each connect to a different power source, may be powered by the same power source, or be powered by multiple power sources.

Any type of power source may be used to power robotic system 100, such as electrical power or a gasoline engine. Additionally or alternatively, robotic system 100 may include a hydraulic system configured to provide power to mechanical components 110 using fluid power. Components of robotic system 100 may operate based on hydraulic fluid being transmitted throughout the hydraulic system to various hydraulic motors and hydraulic cylinders, for example. The hydraulic system may transfer hydraulic power by way of pressurized hydraulic fluid through tubes, flexible hoses, or other links between components of robotic system 100. Power source(s) 114 may charge using various types of charging, such as wired connections to an outside power source, wireless charging, combustion, or other examples.

Electrical components 116 may include various mechanisms capable of processing, transferring, or providing electrical charge or electric signals. Among possible examples, electrical components 116 may include electrical wires, circuitry, or wireless communication transmitters and receivers to enable operations of robotic system 100. Electrical components 116 may interwork with mechanical components 110 to enable robotic system 100 to perform various operations. Electrical components 116 may be configured to provide power from power source(s) 114 to the various mechanical components 110, for example. Further, robotic system 100 may include electric motors. Other examples of electrical components 116 may exist as well.

Robotic system 100 may include a body, which may connect to or house appendages and components of the robotic system. As such, the structure of the body may vary within examples and may further depend on particular operations that a given robot may have been designed to perform. For example, a robot developed to carry heavy loads may have a wide body that enables placement of the load. Similarly, a robot designed to operate in tight spaces may have a relatively tall, narrow body. Further, the body or the other components may be developed using various types of materials, such as metals or plastics. Within other examples, a robot may have a body with a different structure or made of various types of materials.

The body or the other components may include or carry sensor(s) 112. These sensors may be positioned in various locations on the robotic system 100, such as on a body, a head, a neck, a base, a torso, an arm, or an end effector, among other examples.

Robotic system 100 may be configured to carry a load, such as a type of cargo that is to be transported. In some examples, the load may be placed by the robotic system 100 into a bin or other container attached to the robotic system 100. The load may also represent external batteries or other types of power sources (e.g., solar panels) that the robotic system 100 may utilize. Carrying the load represents one example use for which the robotic system 100 may be configured, but the robotic system 100 may be configured to perform other operations as well.

As noted above, robotic system 100 may include various types of appendages, wheels, end effectors, gripping devices and so on. In some examples, robotic system 100 may include a mobile base with wheels, treads, or some other form of locomotion. Additionally, robotic system 100 may include a robotic arm or some other form of robotic manipulator. In the case of a mobile base, the base may be considered as one of mechanical components 110 and may include wheels, powered by one or more of actuators, which allow for mobility of a robotic arm in addition to the rest of the body.

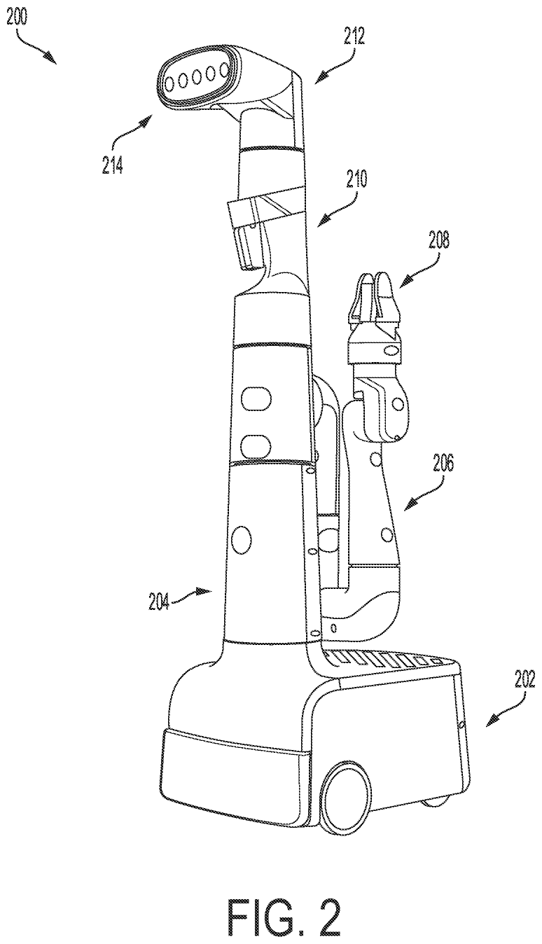

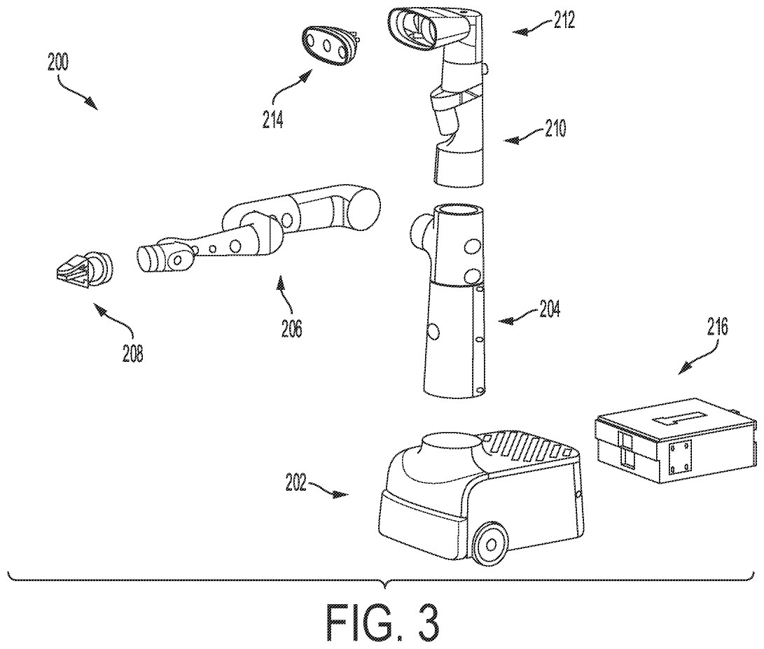

FIG. 2 illustrates a mobile robot, in accordance with example embodiments. FIG. 3 illustrates an exploded view of the mobile robot, in accordance with example embodiments. More specifically, a robot 200 may include a mobile base 202, a midsection 204, an arm 206, an end-of-arm system (EOAS) 208, a mast 210, a perception housing 212, and a perception suite 214. The robot 200 may also include a compute box 216 stored within mobile base 202.

The mobile base 202 includes two drive wheels positioned at a front end of the robot 200 in order to provide locomotion to robot 200. The mobile base 202 also includes additional casters (not shown) to facilitate motion of the mobile base 202 over a ground surface. The mobile base 202 may have a modular architecture that allows compute box 216 to be easily removed. Compute box 216 may serve as a removable control system for robot 200 (rather than a mechanically integrated control system). After removing external shells, the compute box 216 can be easily removed and/or replaced. The mobile base 202 may also be designed to allow for additional modularity. For example, the mobile base 202 may also be designed so that a power system, a battery, and/or external bumpers can all be easily removed and/or replaced.

The midsection 204 may be attached to the mobile base 202 at a front end of the mobile base 202. The midsection 204 includes a mounting column which is fixed to the mobile base 202. The midsection 204 additionally includes a rotational joint for arm 206. More specifically, the midsection 204 includes the first two degrees of freedom for arm 206 (a shoulder yaw J0 joint and a shoulder pitch J1 joint). The mounting column and the shoulder yaw J0 joint may form a portion of a stacked tower at the front of mobile base 202. The mounting column and the shoulder yaw J0 joint may be coaxial. The length of the mounting column of midsection 204 may be chosen to provide the arm 206 with sufficient height to perform manipulation tasks at commonly encountered height levels (e.g., coffee table top and counter top levels). The length of the mounting column of midsection 204 may also allow the shoulder pitch J1 joint to rotate the arm 206 over the mobile base 202 without contacting the mobile base 202.

The arm 206 may be a 7DOF robotic arm when connected to the midsection 204. As noted, the first two DOFs of the arm 206 may be included in the midsection 204. The remaining five DOFs may be included in a standalone section of the arm 206 as illustrated in FIGS. 2 and 3. The arm 206 may be made up of plastic monolithic link structures. Inside the arm 206 may be housed standalone actuator modules, local motor drivers, and thru bore cabling.

The EOAS 208 may be an end effector at the end of arm 206. EOAS 208 may allow the robot 200 to manipulate objects in the environment. As shown in FIGS. 2 and 3, EOAS 208 may be a gripper, such as an underactuated pinch gripper. The gripper may include one or more contact sensors such as force/torque sensors and/or non-contact sensors such as one or more cameras to facilitate object detection and gripper control. EOAS 208 may also be a different type of gripper such as a suction gripper or a different type of tool such as a drill or a brush. EOAS 208 may also be swappable or include swappable components such as gripper digits.

The mast 210 may be a relatively long, narrow component between the shoulder yaw J0 joint for arm 206 and perception housing 212. The mast 210 may be part of the stacked tower at the front of mobile base 202. The mast 210 may be fixed relative to the mobile base 202. The mast 210 may be coaxial with the midsection 204. The length of the mast 210 may facilitate perception by perception suite 214 of objects being manipulated by EOAS 208. The mast 210 may have a length such that when the shoulder pitch J1 joint is rotated vertical up, a topmost point of a bicep of the arm 206 is approximately aligned with a top of the mast 210. The length of the mast 210 may then be sufficient to prevent a collision between the perception housing 212 and the arm 206 when the shoulder pitch J1 joint is rotated vertical up.

As shown in FIGS. 2 and 3, the mast 210 may include a 3D lidar sensor configured to collect depth information about the environment. The 3D lidar sensor may be coupled to a carved-out portion of the mast 210 and fixed at a downward angle. The lidar position may be optimized for localization, navigation, and for front cliff detection.

The perception housing 212 may include at least one sensor making up perception suite 214. The perception housing 212 may be connected to a pan/tilt control to allow for reorienting of the perception housing 212 (e.g., to view objects being manipulated by EOAS 208). The perception housing 212 may be a part of the stacked tower fixed to the mobile base 202. A rear portion of the perception housing 212 may be coaxial with the mast 210.

The perception suite 214 may include a suite of sensors configured to collect sensor data representative of the environment of the robot 200. The perception suite 214 may include an infrared (IR)-assisted stereo depth sensor. The perception suite 214 may additionally include a wide-angled red-green-blue (RGB) camera for human-robot interaction and context information. The perception suite 214 may additionally include a high resolution RGB camera for object classification. A face light ring surrounding the perception suite 214 may also be included for improved human-robot interaction and scene illumination. In some examples, the perception suite 214 may also include a projector configured to project images and/or video into the environment.

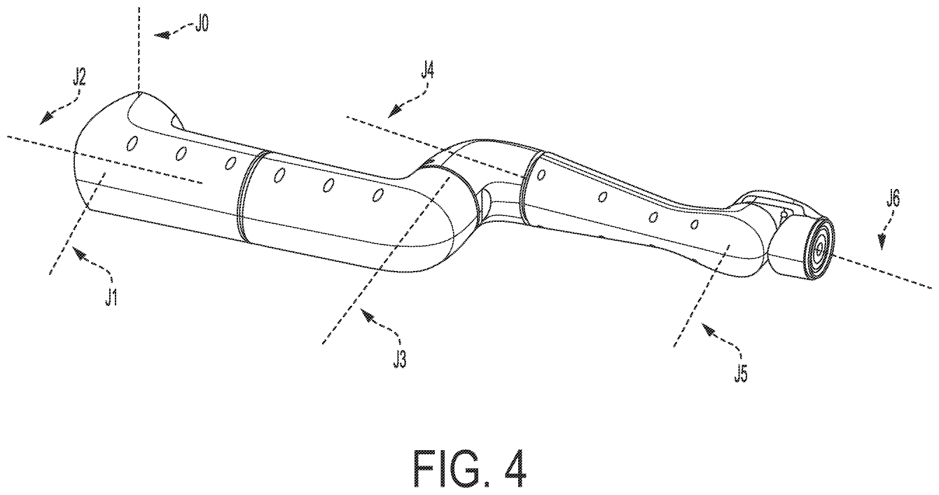

FIG. 4 illustrates a robotic arm, in accordance with example embodiments. The robotic arm includes 7 DOFs: a shoulder yaw J0 joint, a shoulder pitch J1 joint, a bicep roll J2 joint, an elbow pitch J3 joint, a forearm roll J4 joint, a wrist pitch J5 joint, and wrist roll J6 joint. Each of the joints may be coupled to one or more actuators. The actuators coupled to the joints may be operable to cause movement of links down the kinematic chain (as well as any end effector attached to the robot arm).

The shoulder yaw J0 joint allows the robot arm to rotate toward the front and toward the back of the robot. One beneficial use of this motion is to allow the robot to pick up an object in front of the robot and quickly place the object on the rear section of the robot (as well as the reverse motion). Another beneficial use of this motion is to quickly move the robot arm from a stowed configuration behind the robot to an active position in front of the robot (as well as the reverse motion).

The shoulder pitch J1 joint allows the robot to lift the robot arm (e.g., so that the bicep is up to perception suite level on the robot) and to lower the robot arm (e.g., so that the bicep is just above the mobile base). This motion is beneficial to allow the robot to efficiently perform manipulation operations (e.g., top grasps and side grasps) at different target height levels in the environment. For instance, the shoulder pitch J1 joint may be rotated to a vertical up position to allow the robot to easily manipulate objects on a table in the environment. The shoulder pitch J1 joint may be rotated to a vertical down position to allow the robot to easily manipulate objects on a ground surface in the environment.

The bicep roll J2 joint allows the robot to rotate the bicep to move the elbow and forearm relative to the bicep. This motion may be particularly beneficial for facilitating a clear view of the EOAS by the robot's perception suite. By rotating the bicep roll J2 joint, the robot may kick out the elbow and forearm to improve line of sight to an object held in a gripper of the robot.

Moving down the kinematic chain, alternating pitch and roll joints (a shoulder pitch J1 joint, a bicep roll J2 joint, an elbow pitch J3 joint, a forearm roll J4 joint, a wrist pitch J5 joint, and wrist roll J6 joint) are provided to improve the manipulability of the robotic arm. The axes of the wrist pitch J5 joint, the wrist roll J6 joint, and the forearm roll J4 joint are intersecting for reduced arm motion to reorient objects. The wrist roll J6 point is provided instead of two pitch joints in the wrist in order to improve object rotation.

In some examples, a robotic arm such as the one illustrated in FIG. 4 may be capable of operating in a teach mode. In particular, teach mode may be an operating mode of the robotic arm that allows a user to physically interact with and guide robotic arm towards carrying out and recording various movements. In a teaching mode, an external force is applied (e.g., by the user) to the robotic arm based on a teaching input that is intended to teach the robot regarding how to carry out a specific task. The robotic arm may thus obtain data regarding how to carry out the specific task based on instructions and guidance from the user. Such data may relate to a plurality of configurations of mechanical components, joint position data, velocity data, acceleration data, torque data, force data, and power data, among other possibilities.

During teach mode the user may grasp onto the EOAS or wrist in some examples or onto any part of robotic arm in other examples, and provide an external force by physically moving robotic arm. In particular, the user may guide the robotic arm towards grasping onto an object and then moving the object from a first location to a second location. As the user guides the robotic arm during teach mode, the robot may obtain and record data related to the movement such that the robotic arm may be configured to independently carry out the task at a future time during independent operation (e.g., when the robotic arm operates independently outside of teach mode). In some examples, external forces may also be applied by other entities in the physical workspace such as by other objects, machines, or robotic systems, among other possibilities.

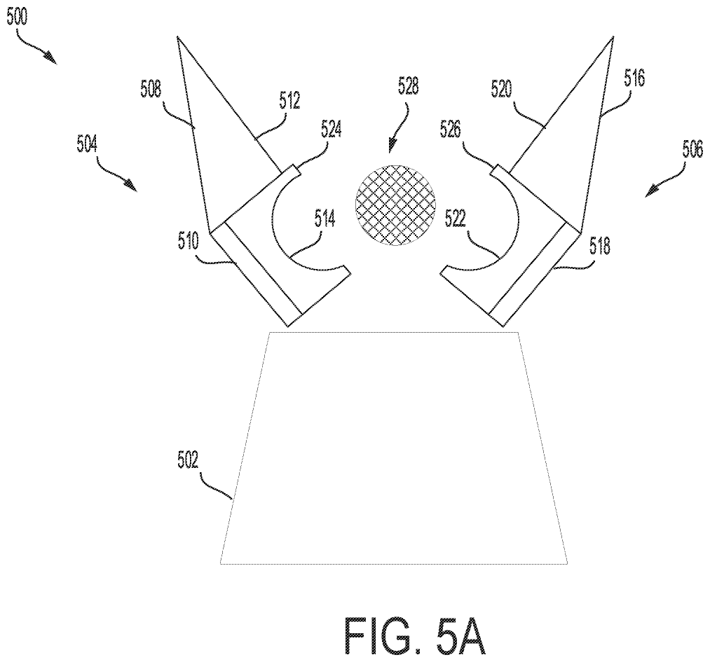

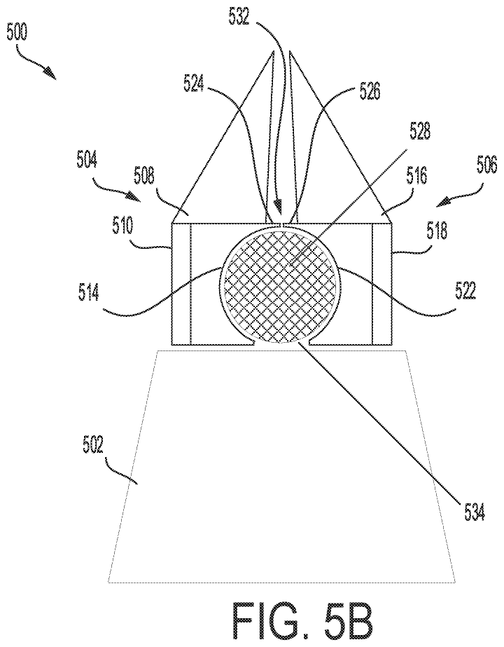

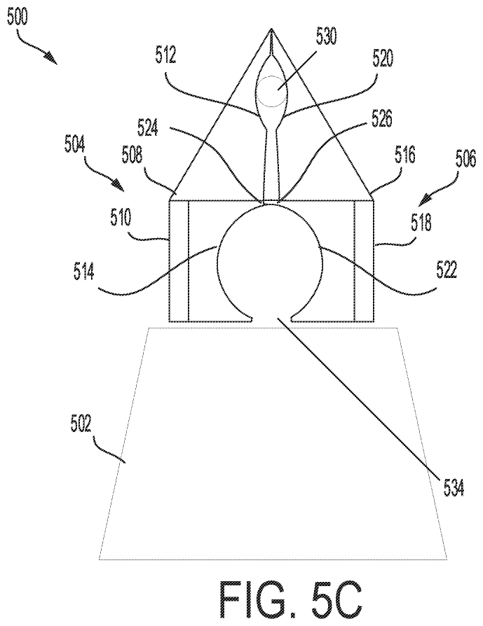

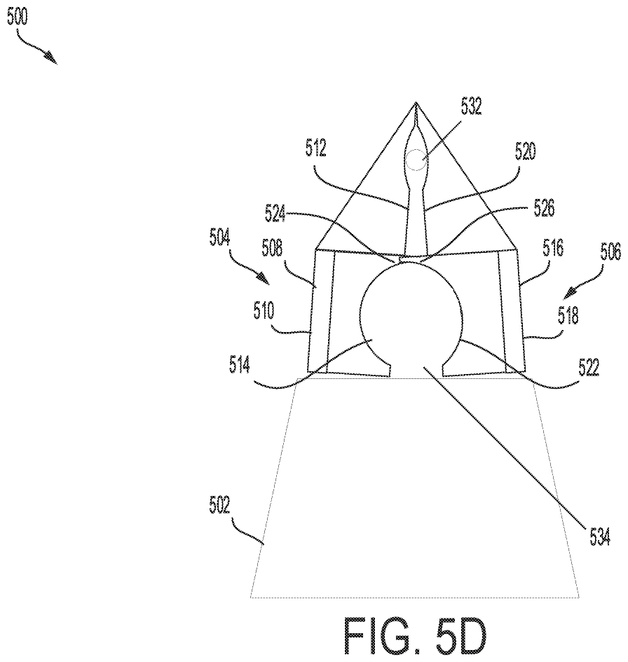

FIGS. 5A-5C depict an example apparatus 500 having a base 502 supporting first gripping component 504 and second gripping component 506, in accordance with example embodiments. The first gripping component 504 may comprise a first distal region 508 and a first proximal region 510. The first distal region 508 may include a first shape-adaptive finger 512. The first proximal region 510 may include a first rigid geometry 514 configured to receive a handle 528 of a tool. The second gripping component 506 may comprise a second distal region 516 and a second proximal region 518. The second distal region 516 may include a second shape-adaptive finger 520. The second proximal region 518 may include a second rigid geometry 522 configured to receive the handle 528 of the tool. Further, in some embodiments, as shown in FIG. 5B, the first distal region 508 of the first gripping component 504 is separated by a clearance 532 from the second distal region 516 of the second gripping component 506 when the first rigid geometry 514 and the second rigid geometry 522 are grasping the handle 528 of the tool. Because clearance 532 exists, no force is being exerted on the first distal region 508 or the second distal region 516, which allows all of the force to concentrate on the enveloping grasp of the handle 528 of the tool. In addition, a proximal clearance 534 exists between the first rigid geometry 514 and the second rigid geometry 522, allowing for all available force to be directed to the handle grasp. This aids in the efficiency of the apparatus 500.

However, as shown in FIG. 5C, in an absence of the handle 528 of the tool, the motion of the first proximal region 510 of the first gripping component 504, the opposing motion of the second proximal region 518 of the second gripping component 506, and the maintained proximal clearance 534 therebetween, enable a pinch grip between the first shape-adaptive finger 512 of the first gripping component 504 and the second shape-adaptive finger 520 of the second gripping component 506 around object 530. In the absence of the handle 528 of the tool, the first proximal region 510 and the second proximal region 518 are moved closer to one another than if the handle 528 of the tool was between them. As such, no force is exerted on the first proximal region 510 or the second proximal region 518 such that all of the available force is transferred to the first shape-adaptive finger 512 of the first gripping component 504 and the second shape-adaptive finger 520 of the second gripping component 506 to pinch the object 530 between them. As shown in FIG. 5C, the first shape-adaptive finger 512 of the first gripping component 504 and the second shape-adaptive finger 520 of the second gripping component 506 are deformable based on the geometry of the object 530.

In some embodiments, apparatus 500 includes a first gripping component 504 further comprising a plurality of first tines 524 and a second gripping component 506 further comprising a plurality of second tines 526. In the absence of the handle 528 of the tool, as shown in FIG. 5C, the plurality of first tines 524 are configured to interdigitate with the plurality of second tines 526 such that the first shape-adaptive finger 512 and the second shape-adaptive finger 520 are able to pinch an object 530 between them without altering the shape of the first rigid geometry 514 or the second rigid geometry 522.

Similarly, in FIG. 5D, when a smaller object 532 is pinched between the first shape-adaptive finger 512 of the first gripping component 504 and the second shape-adaptive finger 520 of the second gripping component 506, the first proximal region 510 and the second proximal region 518 are moved closer to one another than when the larger object 530 is pinched while still retaining the proximal clearance 534. As such, the first gripping component 504 and the second gripping component 506 move beyond vertical as the plurality of first tines 524 and the plurality of second tines 526 interdigit further.

In some embodiments, the first rigid geometry 514 of the first proximal region 510 of the first gripping component 504 comprises a semi-cylinder as shown in FIGS. 5A-5D and the second rigid geometry 522 of the second proximal region 518 of the second gripping component 506 also comprises a semi-cylinder as shown in FIGS. 5A-5D. Other rigid geometries, such as elliptical, square, rectangular, triangular, polygonal, and the like are also possible.

In some embodiments, the first shape-adaptive finger 512 and the second shape-adaptive finger 520 are both underactuated. The underactuated first shape-adaptive finger 512 may include a first deformable gripping surface and the underactuated second shape-adaptive finger 520 may include a second deformable gripping surface. In some examples, the first deformable gripping surface and the second deformable gripping surface may each comprise a respective plurality of members coupled together end-to-end to create a respective elongated gripping surface.

In some examples, the first gripping component 504 and the second gripping component 506 are positioned on base 502 and are actuated to move towards and away from each other. For instance, one or more actuators may be configured to impart rotational and/or linear motion to the first gripping component 504 and the second gripping component 506 to open and close the gripper.

In some embodiments, the first shape-adaptive finger 512 is configured to be interchanged with a first interchangeable shape-adaptive finger 512 and the second shape-adaptive finger 520 is configured to be interchanged with a second interchangeable shape-adaptive finger. For instance, the first and second interchangeable shape-adaptive fingers can have a different size, shape, and/or purpose than the first and second shape-adaptive fingers. The first and second interchangeable shape-adaptive fingers could be actuated or underactuated, or may be suitable for one specific task, such as pinching an object with a specific geometry.

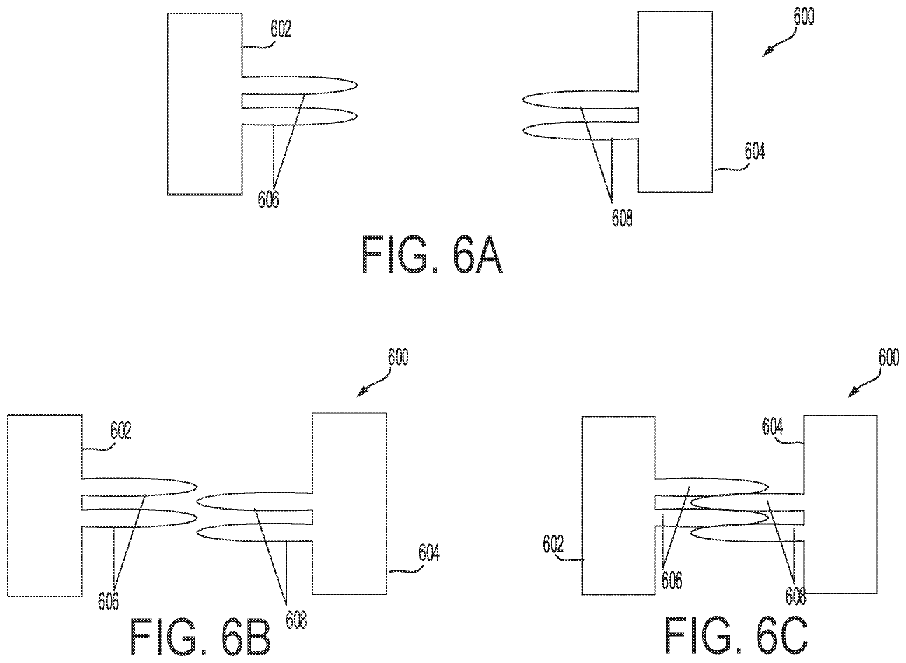

FIGS. 6A-6C illustrate top views of a first gripping component 602 and a second gripping component 604. First gripping component 602 includes a plurality of first tines 606 and second gripping component 604 includes a plurality of second tines 608. The plurality of first tines 606 and the plurality of second tines 608 are spaced apart, as shown in FIG. 6A, when first gripping component 602 and second gripping component 604 are in an open gripping position, allowing space for a handle of a tool to pass. As a handle of a tool is enveloped, as shown in FIG. 6B, first gripping component 602 and second gripping component 604 are closer together than when in an open position, but there is still a clearance between the plurality of first tines 606 and the plurality of second tines 608. However, in a closed position and in the absence of a handle of a tool, as shown in FIG. 6C, the first gripping component 602 and the second gripping component 604 are moved together, and the plurality of first tines 606 are configured to interdigitate with the plurality of second tines 608. In some examples, the plurality of first tines 606 and the plurality of second tines 608 each include exactly two tines, as shown in FIGS. 6A-6C.

Each tine of the plurality of first tines 606 and each tine of the plurality of second tines 608 may each comprise a variety of shapes. For instance, each tine could include a rectangular body shape with a sharp point on an end of the tine. In some examples, each tine could be broad and flat or skinny and rounded. Each tine may include a constant thickness from a base of the tine to the end of the tine, each tine may vary in thickness linearly from a base of the tine to the end of the tine, or each tine may vary inconsistently from a base of the tine to the end of the tine. In some examples, each tine may comprise a rounded, thinner line that curls at the end of the tine, creating a basket-like or cup-like shape, as is shown in FIGS. 6A-6C. In other embodiments, each tine may remain straight from a base of the tine to an edge of the tine. In some embodiments, each tine may include a blunted, rounded edge or a sharp, diamond-shaped edge. Each tine of the plurality of first tines 606 and each tine of the plurality of second tines 608 may include any combination of potential shapes and sizes of tines.

In some examples, each first tine of the plurality of first tines 606 is spaced by a first width having a distance of at least one second tine and each second tine of the plurality of second tines 608 is spaced by a second width having a distance of at least one first tine. In such embodiments, the plurality of first tines 606 may be offset from the plurality of second tines 608 such that each first tine in the plurality of first tines 606 is configured to interdigitate into the second distance between each second tine in the plurality of second tines 608 and each second tine in the plurality of second tines 608 is configured to interdigitate into the first distance between each first tine in the plurality of first tines 606. In some embodiments, each first tine and each second tine have equal width, thereby including a first distance and a second distance that are equal. In other embodiments, each first tine and each second tine do not have equal width, and the first distance and the second distance may or may not be equal.

To help in operation, having the plurality of first tines 606 and the plurality of second tines 608 be spaced apart allows for enough clearance such that a handle of a tool might be enveloped between a portion of the first gripping component 602 and the second gripping component 604. Because of the geometry, when the handle of the tool is between them, all of the force is able to be utilized to strengthen the enveloping grip around the handle of the tool. However, in the absence of the handle of the tool, the first plurality of tines 606 and the second plurality of tines 608 are able to interdigitate, which has several benefits. For instance, because the first plurality of tines 606 and the second plurality of tines 608 are able to interdigitate, the remaining portion of the first gripping component 602 and the second gripping component 604 are able to be moved close enough to functionally pinch an object between them. In addition, by allowing the first plurality of tines 606 and the second plurality of tines 608 to interdigitate without use of force saves the force such that the apparatus is able to channel that force into the remaining parts of the first gripping component 602 and the second gripping component 604 to pinch an object between them.

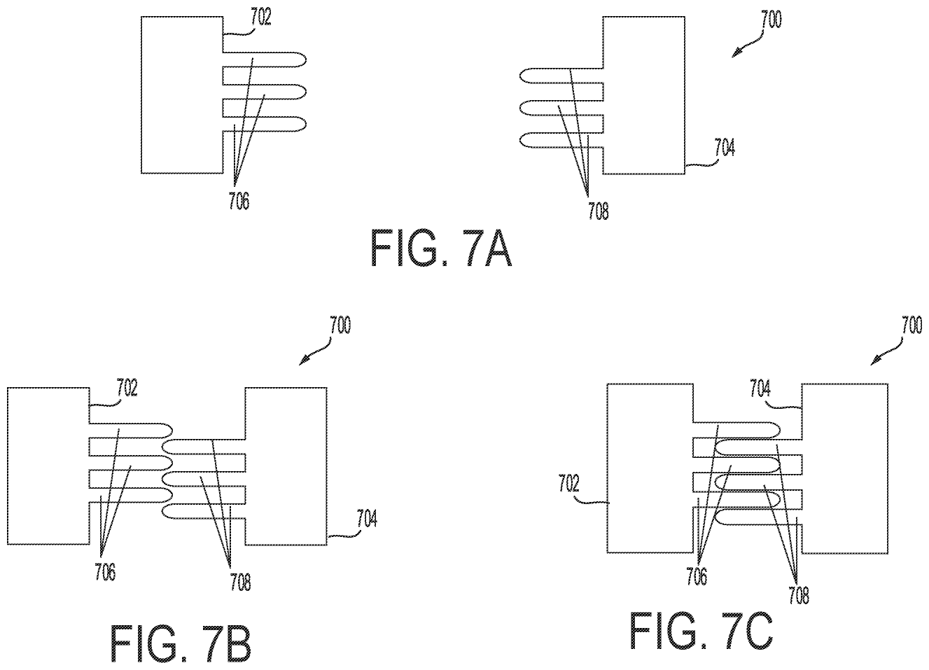

Similarly, FIGS. 7A-7C illustrate top views of a first gripping component 702 and a second gripping component 704. First gripping component 702 includes a plurality of first tines 706 and second gripping component 704 includes a plurality of second tines 708. The plurality of first tines 706 and the plurality of second tines 708 are spaced apart, as shown in FIG. 7A, when first gripping component 702 and second gripping component 704 are in an open position, allowing for a handle of a tool to pass. As a handle of a tool is enveloped, as shown in FIG. 7B, first gripping component 702 and second gripping component 704 are closer together than when in an open position, but there is still a clearance between the plurality of first tines 706 and the plurality of second tines 708. However, in a closed position and in the absence of a handle of a tool, as shown in FIG. 7C, the first gripping component 702 and the second gripping component 704 are moved together, and the plurality of first tines 706 are configured to interdigitate with the plurality of second tines 708. In some examples, the plurality of first tines 706 and the plurality of second tines 708 each include exactly three tines, as shown in FIGS. 7A-7C. Each tine of the plurality of first tines 706 and the plurality of second tines 708 may comprise any number of shapes, sizes, and thicknesses, as aforementioned in the embodiment shown in FIGS. 6A-6C.

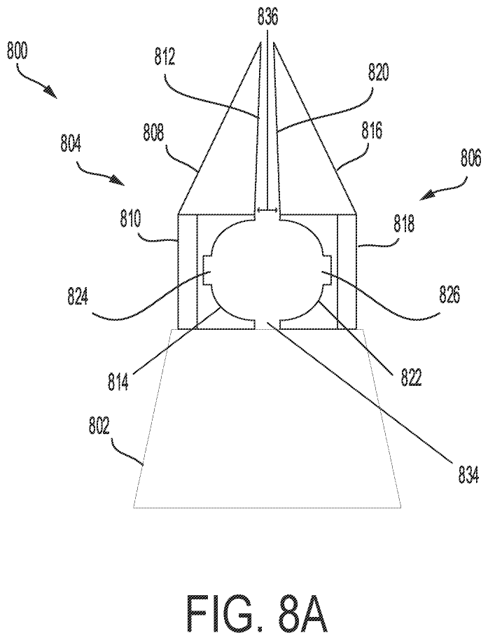

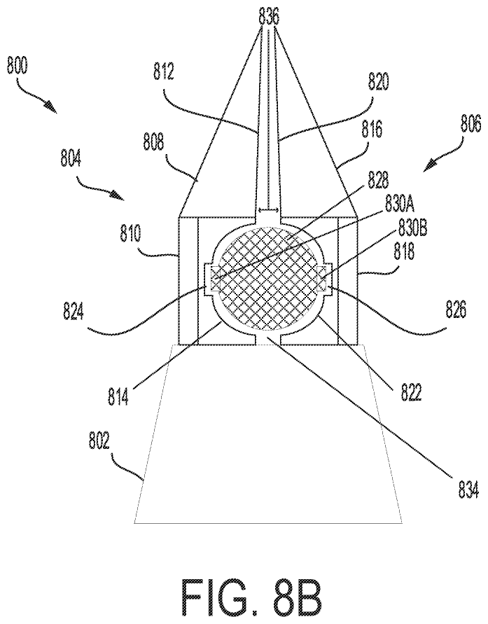

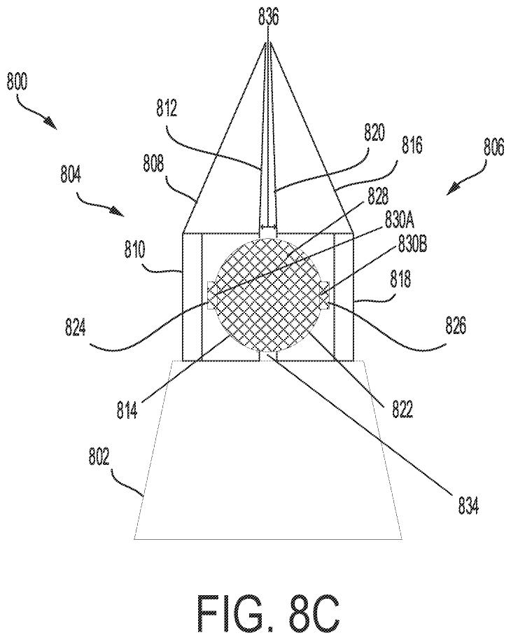

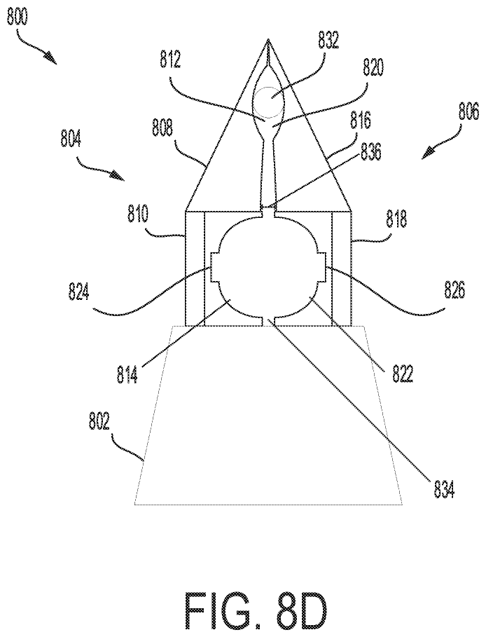

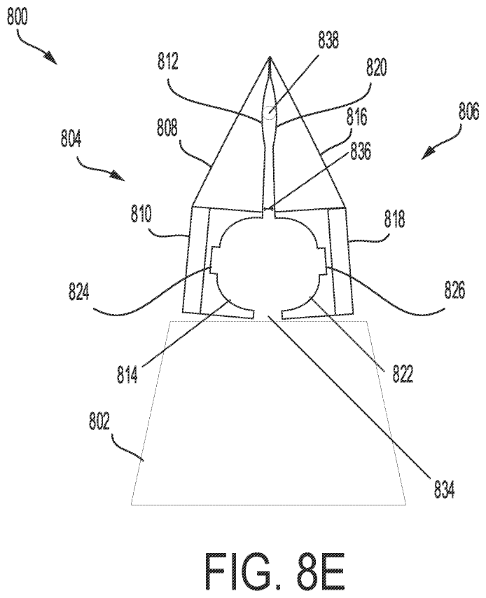

FIGS. 8A-8C depict another example apparatus 800 having a base 802 supporting first gripping component 804 and second gripping component 806, in accordance with example embodiments. The first gripping component 804 may comprise a first distal region 808 and a first proximal region 810. The first distal region 808 may include a first shape-adaptive finger 812. In some embodiments, the first proximal region 810 includes a first rigid geometry 814 with a first keyway 824 configured to receive a handle 828 of a tool with a first key 830A, such that the first key 830A is configured to be received in the first keyway 824 of the first gripping component 804. Similarly, the second gripping component 806 may comprise a second distal region 816 and a second proximal region 818. The second distal region 816 may include a second shape-adaptive finger 820. The second proximal region 818 may include a second rigid geometry 822 with a second keyway 826 configured to receive a handle 828 of a tool with a second key 830B, such that the second key 830B is configured to be received in the second keyway 826 of the second gripping component 806. In some embodiments, the first proximal region 810 and the second proximal region 816 may each be configured to have a first rigid geometry 814 and a second rigid geometry 822, including first keyway 824 and a second keyway 826, respectively, that is configured to receive a handle 828 of a tool specifically designed to have keys 830A and 830B that fit into first keyway 824 and second keyway 826 to obtain a strong enveloping grasp. In addition, because the keys 830A and 830B on the handle 828 of the tool fit into first keyway 824 and second keyway 826 of the apparatus 800, undesired and uncontrolled tool yaw is prevented when loads are present in the yaw direction. In the event that a handle of a tool has a circular cross-section without keys 830A and 830B, the handle 828 of the tool might rotate when exposed to the forces in the yaw direction. However, by incorporating keys 830A and 830B, rotation in the yaw direction is prevented.

In other embodiments, the handle 828 of the tool has a non-circular cross section, such as a splined, a polygonal, or a lobular shape. In such embodiments, the first rigid geometry and the second rigid geometry are configured to receive the non-circular cross sectional shape of the handle of the tool such that the handle of the tool is prevented from rotating in a yaw direction. For example, the handle 828 of the tool may have a square cross-section. As such, the first rigid geometry and the second rigid geometry could be shaped such that two diagonal corners of the square-shaped handle 828 of the tool fit into a v-notch in each respective rigid geometry.

Further, in some embodiments, as shown in FIG. 8C, the first distal region 808 of the first gripping component 804 is separated by a distal clearance 836 from the second distal region 816 of the second gripping component 806 when the first rigid geometry 814 and the second rigid geometry 822 are grasping the handle 828 of the tool to allow for the entirety of the available force to be utilized towards securing the enveloping grasp of the handle 828 of the tool. However, as shown in 8D, in an absence of the handle 828 of the tool, the motion of the first proximal region 810 of the first gripping component 804, the opposing motion of the second proximal region 818 of the second gripping component 806, and the maintained clearance therebetween, enables a pinch grip between the first shape-adaptive finger 812 of the first gripping component 804 and the second shape-adaptive finger 820 of the second gripping component 806 around an object 832. In some embodiments, the first proximal portion 810 of the first gripping component 804 and the second proximal portion 818 of the second gripping component 806 are separated at base 802 by a proximal clearance 834. The proximal clearance 834 allows for the first shape-adaptive finger 812 and the second shape-adaptive finger 820 to be positioned in a pinch grip without contact between the first rigid geometry 814 and the second rigid geometry 822 as the first gripping component 804 and the second gripping component 806 move from an open position in relation to each other to a closed position in relation to each other.

Similarly, in FIG. 8E, when a smaller object 838 is pinched between the first shape-adaptive finger 812 of the first gripping component 804 and the second shape-adaptive finger 820 of the second gripping component 806, the first proximal region 810 and the second proximal region 818 are moved closer to one another than when the larger object 832 is pinched while still retaining the proximal clearance 834. However, even as the first shape-adaptive finger 812 and the second shape-adaptive finger 820 are moved closer (beyond vertical), distal clearance 836 is not eliminated.

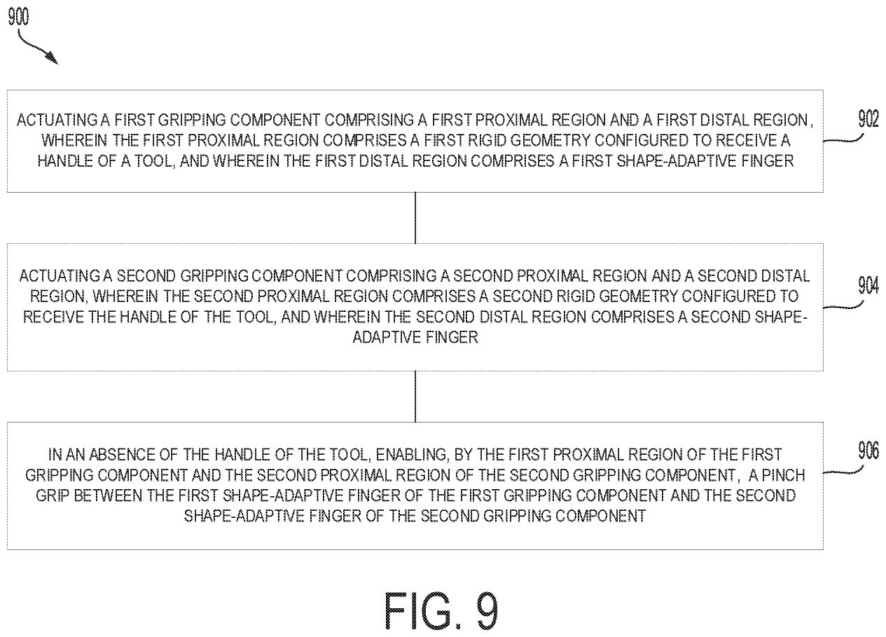

FIG. 9 is a block diagram of a method, in accordance with example embodiments. In some examples, method 900 of FIG. 9 may be carried out by a robotic device with a gripper, such as robotic system 100. In further examples, a portion of method 900 may be carried out by one or more processors, such as processor(s) 102, executing program instructions, such as program instructions 106, stored in a data storage, such as data storage 104. Execution of method 900 may involve a robotic device, such as the robotic device illustrated and described with respect to FIGS. 1-4, integrated with the apparatus illustrated in FIGS. 5A-8D. Other robotic devices may also be used in the performance of method 900. In further examples, some or all of the blocks of method 900 may be performed by a control system remote from the robotic device. In yet further examples, different blocks of method 900 may be performed by different control systems, located on and/or remote from a robotic device.

At block 902, method 900 includes actuating a first gripping component comprising a first proximal region and a first distal region such that the first proximal region comprises a first rigid geometry configured to receive a handle of a tool and the first distal region comprises a first shape-adaptive finger.

At block 904, method 900 includes actuating a second gripping component comprising a second proximal region and a second distal region such that the second proximal region comprises a second rigid geometry configured to receive the handle of the tool and the second distal region comprises a second shape-adaptive finger. In some examples, the functions in block 902 occur simultaneously with the functions in block 904. In other examples, the functions in block 902 occur at different times than the functions in block 904.

At block 906, method 900 includes, in an absence of the handle of the tool, enabling, by the motion of the first proximal region of the first gripping component, the opposing motion of the second proximal region of the second gripping component, and the maintained clearance therebetween, a pinch grip between the first shape-adaptive finger of the first gripping component and the second shape-adaptive finger of the second gripping component.

In some examples of method 900, the first rigid geometry of the first gripping component comprises a plurality of first tines and the second rigid geometry of the second gripping component comprises a plurality of second tines. In some examples, the plurality of first tines of the first gripping component are configured to interdigitate with the plurality of second tines of the second gripping component in the absence of the handle of the tool to enable the pinch grip between the first shape-adaptive finger of the first gripping component and the second shape-adaptive finger of the second gripping component.

In some examples of method 900, the first rigid geometry comprises a first keyway and the second rigid geometry comprises a second keyway such that the handle of the tool comprises a first key and a second key. As such, the first key is configured to couple with the first keyway of the first rigid geometry and the second key is configured to couple with the second keyway of the second rigid geometry such that the first rigid geometry of the first gripping component and the second rigid geometry of the second gripping component are configured to be spaced apart when grasping the handle of the tool.

Method 900 may be performed using an example apparatus which includes a first gripping component including a first proximal region having a first rigid geometry configured to receive a handle of a tool and a first distal region having a first shape-adaptive finger. The apparatus may also include a second gripping component including a second proximal region having a second rigid geometry configured to receive a handle of a tool and a second distal region having a second shape-adaptive finger. In some examples, the first distal region of the first gripping component is separated by a clearance from the second distal region of the second gripping component when the first rigid geometry and the second rigid geometry are grasping the handle of the tool. In an absence of the handle of the tool, the first proximal region of the first gripping component and the second proximal region of the second gripping component may enable a pinch grip between the first shape-adaptive finger of the first gripping component and the second shape-adaptive finger of the second gripping component.

In some examples, the first rigid geometry comprises a plurality of first tines and the second rigid geometry comprises a plurality of second tines. Further, in some embodiments, the plurality of first tines of the first gripping component are configured to interdigitate with the plurality of second tines of the second gripping component in the absence of the handle of the tool to enable the pinch grip between the first shape-adaptive finger of the first gripping component and the second shape-adaptive finger of the second gripping component. In some embodiments, each first tine in the plurality of first tines is spaced by a first distance having a width of at least one second tine and each second tine in the plurality of second tines is spaced by a second distance having a width of at least one first tine. In some embodiments, the plurality of first tines are offset from the plurality of second tines such that each first tine in the plurality of first tines is configured to interdigitate into the second distance between each second tine in the plurality of second tines and each second tine in the plurality of second tines is configured to interdigitate into the first distance between each first tine in the plurality of first tines. In some embodiments, each first tine and each second tine have equal width and the first distance between each first tine and the second distance between each second tine are equal. In some embodiments, the plurality of first tines comprises exactly two first tines and the plurality of second tines comprises exactly two second tines. In some embodiments, the plurality of first tines comprises exactly three first tines and the plurality of second tines comprises exactly three second tines.

In some examples, the first rigid geometry of the first proximal region of the first gripping component comprises a semi-cylinder and the second rigid geometry of the second proximal region of the second gripping component comprises a semi-cylinder.

In some examples, the first shape-adaptive finger is a first underactuated finger and the second shape-adaptive finger is a second underactuated finger. In some embodiments, the first underactuated finger comprises a first deformable gripping surface and the second underactuated finger comprises a second deformable gripping surface. In some embodiments, the first deformable gripping surface and the second deformable gripping surface each comprises a respective plurality of members coupled together end-to-end to create a respective elongated gripping surface.

In some examples, the first shape-adaptive finger is configured to be interchanged with a first interchangeable shape-adaptive finger and the second shape-adaptive finger is configured to be interchanged with a second interchangeable shape-adaptive finger.

In some examples, the first rigid geometry of the first gripping component and the second rigid geometry of the second gripping component are configured to be spaced apart when grasping the handle of the tool. In some embodiments, the first rigid geometry comprises a first keyway and the second rigid geometry comprises a second keyway such that the handle of the tool comprises a first key and a second key and the first key is configured to couple with the first keyway of the first rigid geometry and the second key is configured to couple with the second keyway of the second rigid geometry.

In some examples, the handle of the tool is configured to have a non-circular cross section and the first rigid geometry and the second rigid geometry are configured to receive the non-circular cross sectional shape of the handle of the tool such that the handle of the tool is prevented from rotating in a yaw direction.

An example method of the present disclosure may include actuating a first gripping component that includes a first proximal region having a first rigid geometry configured to receive a handle of a tool and a first distal region having a first shape-adaptive finger and actuating a second gripping component that includes a second proximal region having a second rigid geometry configured to receive a handle of a tool and a second distal region having a second shape-adaptive finger. The method may also include, in an absence of the handle of the tool, enabling, by the first proximal region of the first gripping component and the second proximal region of the second gripping component, a pinch grip between the first shape-adaptive finger of the first gripping component and the second shape-adaptive finger of the second gripping component.

In some examples of the method above, the first rigid geometry comprises a plurality of first tines and the second rigid geometry comprises a plurality of second tines such that the plurality of first tines of the first gripping component are configured to interdigitate with the plurality of second tines of the second gripping component in the absence of the handle of the tool to enable the pinch grip between the first shape-adaptive finger of the first gripping component and the second shape-adaptive finger of the second gripping component.

In some examples of the method above, the first rigid geometry comprises a first keyway and the second rigid geometry comprises a second keyway such that the handle of the tool comprises a first key and a second key and the first key is configured to couple with the first keyway of the first rigid geometry and the second key is configured to couple with the second keyway of the second rigid geometry such that the first rigid geometry of the first gripping component and the second rigid geometry of the second gripping component are configured to be spaced apart when grasping the handle of the tool.

Other arrangements of the apparatus are possible. For example, in some examples, a robotic device includes a robotic gripping device having a first gripping component including a first proximal region having a first rigid geometry configured to receive a handle of a tool and a first distal region having a first shape-adaptive finger. The apparatus may also include a second gripping component including a second proximal region having a second rigid geometry configured to receive a handle of a tool and a second distal region having a second shape-adaptive finger. In some examples, the first distal region of the first gripping component is separated by a clearance from the second distal region of the second gripping component when the first rigid geometry and the second rigid geometry are grasping the handle of the tool. Also, in some embodiments, in an absence of the handle of the tool, the first proximal region of the first gripping component and the second proximal region of the second gripping component enable a pinch grip between the first shape-adaptive finger of the first gripping component and the second shape-adaptive finger of the second gripping component.

### III. Conclusion

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code or related data may be stored on any type of computer readable medium such as a storage device including a disk or hard drive or other storage medium.

The computer readable medium may also include non-transitory computer readable media such as computer-readable media that stores data for short periods of time like register memory, processor cache, and random access memory (RAM). The computer readable media may also include non-transitory computer readable media that stores program code or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software or hardware modules in the same physical device. However, other information transmissions may be between software modules or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. An apparatus comprising:
a first gripping component comprising a first proximal region and a first distal region, wherein the first proximal region comprises a first rigid geometry configured to receive a handle of a tool, and wherein the first distal region comprises a first shape-adaptive finger; and
a second gripping component comprising a second proximal region and a second distal region, wherein the second proximal region comprises a second rigid geometry configured to receive the handle of the tool, and wherein the second distal region comprises a second shape-adaptive finger,
wherein the first distal region of the first gripping component is separated by a clearance from the second distal region of the second gripping component when the first rigid geometry and the second rigid geometry are grasping the handle of the tool, and
wherein, in an absence of the handle of the tool, the first proximal region of the first gripping component and the second proximal region of the second gripping component enable a pinch grip between the first shape-adaptive finger of the first gripping component and the second shape-adaptive finger of the second gripping component.

2. The apparatus of claim 1, wherein the first rigid geometry comprises a plurality of first tines, and wherein the second rigid geometry comprises a plurality of second tines.

3. The apparatus of claim 2, wherein the plurality of first tines of the first gripping component are configured to interdigitate with the plurality of second tines of the second gripping component in the absence of the handle of the tool to enable the pinch grip between the first shape-adaptive finger of the first gripping component and the second shape-adaptive finger of the second gripping component.

4. The apparatus of claim 3, wherein each first tine in the plurality of first tines is spaced by a first distance having a width of at least one second tine, and wherein each second tine in the plurality of second tines is spaced by a second distance having a width of at least one first tine.

5. The apparatus of claim 4, wherein the plurality of first tines are offset from the plurality of second tines such that each first tine in the plurality of first tines is configured to interdigitate into the second distance between each second tine in the plurality of second tines and each second tine in the plurality of second tines is configured to interdigitate into the first distance between each first tine in the plurality of first tines.

6. The apparatus of claim 4, wherein each first tine and each second tine have equal width, and wherein the first distance and the second distance are equal.

7. The apparatus of claim 3, wherein the plurality of first tines comprises exactly two first tines, and wherein the plurality of second tines comprises exactly two second tines.

8. The apparatus of claim 3, wherein the plurality of first tines comprises exactly three first tines, and wherein the plurality of second tines comprises exactly three second tines.

9. The apparatus of claim 1, wherein the first rigid geometry of the first proximal region of the first gripping component comprises a semi-cylinder, and wherein the second rigid geometry of the second proximal region of the second gripping component comprises a semi-cylinder.

10. The apparatus of claim 1, wherein the first shape-adaptive finger is a first underactuated finger and wherein the second shape-adaptive finger is a second underactuated finger.

11. The apparatus of claim 10, wherein the first underactuated finger comprises a first deformable gripping surface and wherein the second underactuated finger comprises a second deformable gripping surface.

12. The apparatus of claim 11, wherein the first deformable gripping surface and the second deformable gripping surface each comprises a respective plurality of members coupled together end-to-end to create a respective elongated gripping surface.

13. The apparatus of claim 1, wherein the first shape-adaptive finger is configured to be interchanged with a first interchangeable shape-adaptive finger and the second shape-adaptive finger is configured to be interchanged with a second interchangeable shape-adaptive finger.

14. The apparatus of claim 1, wherein the first rigid geometry of the first gripping component and the second rigid geometry of the second gripping component are configured to be spaced apart when grasping the handle of the tool.

15. The apparatus of claim 14, wherein the first rigid geometry comprises a first keyway, and wherein the second rigid geometry comprises a second keyway, and wherein the handle of the tool comprises a first key and a second key, and wherein the first key is configured to couple with the first keyway of the first rigid geometry and the second key is configured to couple with the second keyway of the second rigid geometry.

16. The apparatus of claim 14, wherein the handle of the tool has a non-circular cross section, and wherein the first rigid geometry and the second rigid geometry are configured to receive the non-circular cross sectional shape of the handle of the tool such that the handle of the tool is prevented from rotating in a yaw direction.

17. A method comprising:
actuating a first gripping component comprising a first proximal region and a first distal region, wherein the first proximal region comprises a first rigid geometry configured to receive a handle of a tool, and wherein the first distal region comprises a first shape-adaptive finger;
actuating a second gripping component comprising a second proximal region and a second distal region, wherein the second proximal region comprises a second rigid geometry configured to receive the handle of the tool, and wherein the second distal region comprises a second shape-adaptive finger; and
in an absence of the handle of the tool, enabling, by the first proximal region of the first gripping component and the second proximal region of the second gripping component, a pinch grip between the first shape-adaptive finger of the first gripping component and the second shape-adaptive finger of the second gripping component.

18. The method of claim 17, wherein the first rigid geometry comprises a plurality of first tines, and wherein the second rigid geometry comprises a plurality of second tines, and wherein the plurality of first tines of the first gripping component are configured to interdigitate with the plurality of second tines of the second gripping component in the absence of the handle of the tool to enable the pinch grip between the first shape-adaptive finger of the first gripping component and the second shape-adaptive finger of the second gripping component.

19. The method of claim 17, wherein the first rigid geometry comprises a first keyway, and wherein the second rigid geometry comprises a second keyway, and wherein the handle of the tool comprises a first key and a second key, and wherein the first key is configured to couple with the first keyway of the first rigid geometry and the second key is configured to couple with the second keyway of the second rigid geometry, and wherein the first rigid geometry of the first gripping component and the second rigid geometry of the second gripping component are configured to be spaced apart when grasping the handle of the tool.

20. A robotic device comprising:
a robotic gripping apparatus comprising:
a first gripping component comprising a first proximal region and a first distal region, wherein the first proximal region comprises a first rigid geometry configured to receive a handle of a tool, and wherein the first distal region comprises a first shape-adaptive finger; and
a second gripping component comprising a second proximal region and a second distal region, wherein the second proximal region comprises a second rigid geometry configured to receive the handle of the tool, and wherein the second distal region comprises a second shape-adaptive finger,
wherein the first distal region of the first gripping component is separated by a clearance from the second distal region of the second gripping component when the first rigid geometry and the second rigid geometry are grasping the handle of the tool, and
wherein, in an absence of the handle of the tool, the first proximal region of the first gripping component and the second proximal region of the second gripping component enable a pinch grip between the first shape-adaptive finger of the first gripping component and the second shape-adaptive finger of the second gripping component.
